(19) United States
(12) Patent Application Publication
(10) Pub. No.: US 2013/0170404 A1
(43) Pub. Date: Jul. 4, 2013

(54) CONTROL CAPABILITIES FOR INFORMATION RECORDING SESSIONS

(71) Applicants: Jayakumar Balaji, Chennai (IN); Balasubramanian Gopalasubramanian, Chennai (IN); Sugumaran Prasanna Kumar, Chennai (IN); Muthukaruppan Rajesh Krishnan, Chennai (IN); Syed Sulaiman, Chennai (IN)

(72) Inventors: Jayakumar Balaji, Chennai (IN); Balasubramanian Gopalasubramanian, Chennai (IN); Sugumaran Prasanna Kumar, Chennai (IN); Muthukaruppan Rajesh Krishnan, Chennai (IN); Syed Sulaiman, Chennai (IN)

(73) Assignee: ALCATEL-LUCENT, Paris (FR)

(21) Appl. No.: 13/806,887

(22) PCT Filed: Sep. 14, 2010
(86) PCT No.: PCT/EP2010/063464

§ 371 Date: Mar. 11, 2013

(30) Foreign Application Priority Data
Jul. 16, 2010 (IN) 2037/CHE/2010

(51) Int. Cl. H04L 29/06

(52) U.S. Cl. CPC H04L 65/1066
USPC 370/259

(57) ABSTRACT

The present invention relates to Intelligent Networks and, more particularly, to information recording sessions in Intelligent Networks, a method for enabling control capabilities for information recording session with a user in an Intelligent Network, the network comprises a Media Gateway Controller, a Service Control Point and a Media Server. The Service Control Point sends the control capabilities to the Media Gateway Controller and the Media Gateway Controller maps the control capabilities to a control information message. The Media Gateway Controller sends the control information message to the Media Server and the Media Server controls the information recording session based on the control capabilities present in the control information message.

### TECHNICAL FIELD

The present invention relates to Intelligent Networks and, more particularly, to information recording sessions in Intelligent Networks.

### BACKGROUND

Users in a communication network may communicate some information to the network. For example, a user may wish to communicate with a destination user, if the destination user is busy, then the user can convey a message to the network and have the network deliver the message to the destination user at a later point in time. The information may be in the form of an audio message. The network may receive the information, record and store the information. The network starts a recording session with the user in order to obtain information from the user. In Intelligent Networks (INs), the network does not have control over the recording session, once the session has started. For example, if the recording session has started but the user does not communicate any information to the network, then the network does not know whether to continue waiting for any information or to terminate the recording session after a pre-determined duration of time. Similarly, if the user has started communicating information to the network, and if the user suddenly pauses communicating information to the network, then the network does not know whether to continue waiting for more information or to terminate the recording session after a pre-determined duration of time.

Greater control over recording session would mean that the network is free from any indefinite periods of uncertainty arising from situations where there is no information transfer happening between the user and the network. The indefinite periods of uncertainty could occur even though a recording session has started between the user and the network.

### SUMMARY

In view of the foregoing, an embodiment herein provides a method for enabling control capabilities for information recording session with a user in an Intelligent Network; the network comprises a Media Gateway Controller, a Service Control Point and a Media Server. The Service Control Point sends the control capabilities to the Media Gateway Controller and the Media Gateway Controller maps the control capabilities to a control information message. The Media Gateway Controller sends the control information message to the Media Server and the Media Server controls the information recording session based on the control capabilities present in the control information message. The Service Control Point sends the control capabilities to the Media Gateway Controller in a Prompt and Receive Message (PARM) and the Media Gateway Controller maps the control capabilities to a Session Initiation Protocol (SIP) INFO message using Media Server Markup Language (MSML) format. The control capabilities are at least one of time period within which the information recording session should start, allowed time period of silence in the information recording session, voice activity detection to start the information recording session, voice activity detection to end the information recording session, playing a beep sound during the information recording session, appending recorded information to a recording location, pause the recording session and resume the information recording session. The network uses at least one of Intelligent Network Application Part (INAP) and Customized Applications for Mobile Network Enhanced Logic (CAMEL).

Embodiments further disclose a Service Control Point for enabling control capabilities for information recording session with a user in an Intelligent Network, the network further comprising a Media Gateway Controller and a Media Server. The Service Control Point sends the control capabilities to the Media Gateway Controller to enable the Media Server to control the information recording session. The Service Control Point is adapted to send the control capabilities to the Media Gateway Controller in a Prompt and Receive Message (PARM).

Embodiments herein also disclose a Media Gateway Controller for enabling control capabilities for information recording session with a user in an Intelligent Network, the network further comprising a Service Control Point and a Media Server. The Media Gateway Controller receives the control capabilities from a Service Control Point, maps the control capabilities to a control information message and sends the control information message to the Media Server. The Media Gateway Controller maps the control capabilities to a Session Initiation Protocol (SIP) INFO message using Media Server Markup Language (MSML) format.

Also, disclosed herein is a Media Server for enabling control capabilities for information recording session with a user in an Intelligent Network, the network further comprising of a Service Control Point and a Media Gateway Controller. The Media Server receives the control capabilities from the Media Gateway Controller in a control information message and controls the information recording session based on the control capabilities present in the control information message. The Media Server receives the control information message in a Session Initiation Protocol (SIP) INFO message using Media Server Markup Language (MSML) format. The network uses at least one of Intelligent Network Application Part (INAP) and Customized Applications for Mobile Network Enhanced Logic (CAMEL).

Also, disclosed herein is a system for enabling control capabilities for information recording session with a user in an Intelligent Network, the network further comprising of a Media Gateway Controller, a Service Control Point and a Media Server. The Service Control Point sends the control capabilities to the Media Gateway Controller and the Media Gateway Controller maps the control capabilities to a control information message. The Media Gateway Controller sends the control information message to the Media Server and the Media Server controls the information recording session based on the control capabilities. The Service Control Point is adapted to send the control capabilities to the Media Gateway Controller in a Prompt and Receive Message (PARM). The Media Gateway Controller is maps the control capabilities to a Session Initiation Protocol (SIP) INFO message using Media Server Markup Language (MSML) format.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of users in an IN, according to an embodiment herein;

FIG. 2 is a block diagram of a Service Control Point (SCP), according to an embodiment herein;

FIG. 3 is a block diagram of a Media Gateway Controller (MGC), according to an embodiment herein;

FIG. 4 is a block diagram of a Media Server (MS), according to an embodiment herein;

FIGS. 5a and 5b are flowcharts depicting a method for enabling control capabilities for information recording sessions, according to an embodiment herein;

FIG. 6 illustrates a flow diagram for an example illustrating use of a control capability during an information recording session, according to an embodiment herein; and

FIG. 7 illustrates a flow diagram for an example illustrating use of a control capability during an information recording session, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

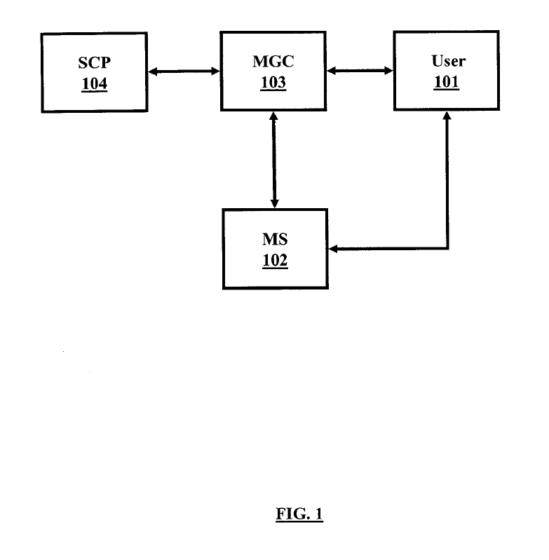

The embodiments herein disclose system and method for enabling control capabilities for information recording sessions with a user in an Intelligent Network. Referring now to the drawings, and more particularly to FIGS. 1 through 7, where similar reference characters denote corresponding features consistently throughout the figures, there are shown embodiments.

FIG. 1 illustrates a block diagram of users in an IN. A user 101 in an IN may communicate information to the network. The information may be any information that the user 101 needs to communicate to the network or to a second user in the network. For example, the information may be a message that the user 101 wants to be delivered to a destination user in the network. The information may be text message, audio message, video message or a combination of at least one of text, audio and video messages. The network initiates a recording session with the user 101, receives the information, records and stores the information. If the message is to be delivered to a destination user, then the network sends the message to the destination user. The information communicated by the user 101 would be received by a Media Server (MS) 102. The user 101 may communicate information to the MS 102 using a communication terminal and the network may use Session Initiation Protocol (SIP), Intelligent Network Application Part (INAP) and/or Customized Applications for Mobile Network Enhanced Logic (CAMEL). The MS 102 is a server that helps establish and maintain a multi media session with the user 101. The MS 102 also stores media and shares the stored media with users of the network. The MS 102 controls the information recording session with the user 101. For example, the MS 102 controls the time period within which the information recording session should start, the allowed time period of silence in the information recording session, voice activity detection to start the information recording session, voice activity detection to end the information recording session, playing a beep sound during said information recording session, appending recorded information to a recording location, pause the recording session and/or resume the recording session. Once the MS 102 receives the complete information from the user 101, the MS 102 records and stores the received information. Before communicating the information, the user 101 initiates a communication link with the network. The user 101 may initiate the communication link by sending a request to a Media Gateway Controller (MGC) 103. The MGC 103 receives signaling information from the MS 102 and instructs the MS 102 to receive information from the user 101. The MGC 103 also acts as a Service Switching Point (SSP) and makes available additional services during a communication session. In other embodiments, the SSP may be a network element located outside the MGC 103. The user may be an IN user and if the user is a Public Switched Telephone Network (PSTN) user, then the PSTN user sends the request to the MGC 103 through a Gateway.

On receiving the request from the user 101 and on determining that information has to be recorded from the user 101, the MGC 103 triggers a Service Control Point (SCP) 104. The SCP 104 is used to help control the services offered by the network. The SCP 104 identifies the number to which a communication session is to be routed and then routes the communication session to the number. The SCP 104 also helps in playing voice messages or prompt announcements to the user 101. The SCP 104 contains the service logic that implements the services related to receiving information from the user 101. On being triggered, the SCP 104 instructs the MS 102, using the MGC 103, to establish a communication link with the user 101. When information has to be recorded from the user 101, the SCP 104 sends a prompt announcement to the MS 102 and instructs the MS 102 that information has to be recorded from the user 101. If an announcement has to be made to the user 101 before recording the information, then the SCP 104 also sends an announcement ID indicating the announcement to be played to user 101 before recording the information. For example, the SCP 104 may send a Prompt and Receive Message (PARM) to the MS 102. A PARM is used to play a prompt announcement and record information from the user 101 and includes the announcement ID of the announcement to be played to the user 101. The prompt announcement played to the user 101 may be “Enter the message”. After the announcement is played to the user 101, the user 101 can communicate the information to the MS 102 and the MS 102 records the received information. The message also includes recorded information ID. The recorded information ID indicates the location in the MS 102 where the recorded information is to be stored. The message may also include control capabilities that can be used by the MS 102 to control the information recording session with the user. For example, a control capability may be to play a “beep” sound to indicate to the user 101 that the user 101 may now start communicating the information to the network.

The SCP 104 sends the message to the MS 102 through the MGC 103. On receiving the message, the MGC 103 maps the message to a control information message that may be interpreted by the MS 102. The MGC 103 maps the prompt announcement ID to the corresponding Uniform Resource Locator (URL) of the prompt announcement and the recorded information ID to the URL of the storage location of the recorded announcement. The URL of the prompt announcement indicates the location of the prompt announcement in the MS 102. The MGC 103 also maps the control capabilities received from the SCP 104 to the control information message and then sends the message to the MS 102.

On receiving the message from the MGC 103, the MS 102 determines that information has to be recorded from the user 101. The MS 102 locates the prompt announcement using the URL of the prompt announcement and plays the prompt announcement to the user 101. The MS 102 may also convey the control options to the user 101 before recording the information communicated by the user 101. For example, the MS 102 may inform the user 101 that the control option to pause the recording session is #3, which can be entered using a communication terminal. The controls options may be conveyed to the user 101 when the user 101 subscribes to the communication network or the controls options may be conveyed to the user 101 during each communication session through a prompt announcement. The control options may be any single key or a combination of multiple keys on the communication terminal and the control options may be sent from the communication to the MS 102 using Dual Tone Multi Frequency (DTMF) signaling. Information transfer between the MS 102 and the user 101 may happen through Real-time Transport Protocol (RTP). When the user 101 communicates the information to the MS 102, the MS 102 controls the recording session with the help of the control capabilities received from the SCP 104. The MS 102 takes the necessary steps in order to see to it that the recording session utilizes the control capabilities. For example, the MS 102 plays a “beep” sound to indicate to the user 101 that the user 101 can now start communicating information to the MS 102. After the user 101 completes communicating the information to the MS 102, the MS 102 stores the recorded information in the location indicated by the URL of the storage location.

Some examples of the control capabilities sent by the SCP 104 are as follows:

Timeout: to start the recording session with in a pre-determined “timeout” period. If the recording session does not start within the “timeout” period, then the MS 102 ends the recording session.

Finalsilence: during the recording session there may be brief periods when the user 101 does not communicate any information to the MS 102. “Finalsilence” is the maximum allowed time period of silence during the recording session. If the period of silence exceeds the value of “Finalsilence”, then the MS 102 ends the recording session.

Vadinitial: to determine if Voice Activity Detection (VAD) is used to initiate the recording session. A valid value of “vadinitial” is Boolean. If “vadinitial” is true, then the MS 102 starts recording if the MS 102 detects a voice signal received from the user 101. If “vadinitial” is false, then the MS 102 does not start recording using VAD.

Vadfinal: to determine if Voice Activity Detection (VAD) is used to end the recording session. A valid value of “vadfinal” is Boolean. If “vadfinal” is true, then the MS 102 ends recording if the MS 102 does not detect a voice signal being received from the user 101 for a pre-determined duration of time. If “vadinitial” is false, then the MS 102 does not end recording using VAD.

Beep: to play a “beep” sound before starting the recording session. A valid value of “beep” is Boolean.

Append: to append the recorded information to a recording location. A valid value of “Append” is Boolean. If “Append” is true, then the recorded information is to be appended to an existing information file present in the recording location. If “Append” is false, then the recorded information is to overwrite any existing information present in the recording location.

Pauseinterval: indicates the time duration for which the MS 102 pause's the recording session.

Pausedigit: maps a Dual-tone multi-frequency signaling (DTMF) key, entered by the user 101, to a pause operation in order to pause the recording session. The prompt announcement is paused for a duration equal to “Pauseinterval”.

Resumedigit: maps a Dual-tone multi-frequency signaling (DTMF) key, entered by the user 101, to a resume operation in order to resume the recording session.

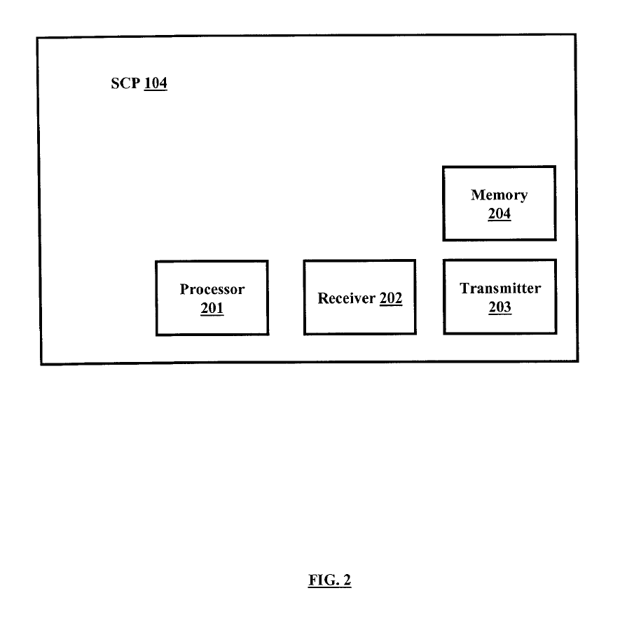

FIG. 2 is a block diagram of a Service Control Point (SCP). A user 101 in an IN may communicate information to the network. The network initiates a recording session with the user 101, receives the information, records and stores the information. If the message is to be delivered to a destination user, then the network sends the message to the destination user. Before communicating the information, the user 101 initiates a communication link with the network. The user 101 may initiate the communication link by sending a request to the MGC 103. On receiving the request from the user 101 and on determining that information has to be recorded from the user 101, the MGC 103 triggers the SCP 104. The SCP 104 receives messages from the MGC 103 through a receiver 202. On being triggered, the SCP 104 instructs the MS 102, using the MGC 103, to establish a communication link with the user 101. The SCP 104 sends messages to the MGC 103 using a transmitter 203. When information has to be recorded from the user 101, the SCP 104 sends a prompt announcement to the MS 102 and instructs the MS 102 that information has to be recorded from the user 101. If an announcement has to be made to the user 101 before recording the information, then the SCP 104 also sends an announcement ID indicating the announcement to be played to user 101 before recording the information. A processor 201 controls the functioning of the MGC 103. All the actions performed by the MGC 103 are coordinated by the processor 201. The processor 201 includes the announcement ID in the message sent to the MGC 103. After the announcement is played to the user 101, the user 101 can communicate the information to the MS 102 and the MS 102 records the received information. The processor 201 also adds the recorded information ID and control capabilities that can be used by the MS 102 to control the information recording session with the user. The SCP 104 stores information about the announcement ID, recorded information ID and the control capabilities in a memory 204. The SCP 104 then sends the message to the MS 102 through the MGC 103 using the transmitter 203. On receiving the message, the MGC 103 maps the message to a control information message that may be interpreted by the MS 102. The MGC 103 maps the prompt announcement ID to the corresponding Uniform Resource Locator (URL) of the prompt announcement and the recorded information ID to the URL of the storage location of the recorded announcement. The URL of the prompt announcement indicates the location of the prompt announcement in the MS 102. The MGC 103 also maps the control capabilities received from the SCP 104 to the control information message and then sends the message to the MS 102.

On receiving the message from the MGC 103, the MS 102 determines that information has to be recorded from the user 101. The MS 102 locates the prompt announcement using the URL of the prompt announcement and plays the prompt announcement to the user 101. When the user 101 communicates the information to the MS 102, the MS 102 controls the recording session with the help of the control capabilities received from the SCP 104. The MS 102 takes the necessary steps in order to see to it that the recording session utilizes the control capabilities. After the user 101 completes communicating the information to the MS 102, the MS 102 stores the recorded information in the location indicated by the URL of the storage location.

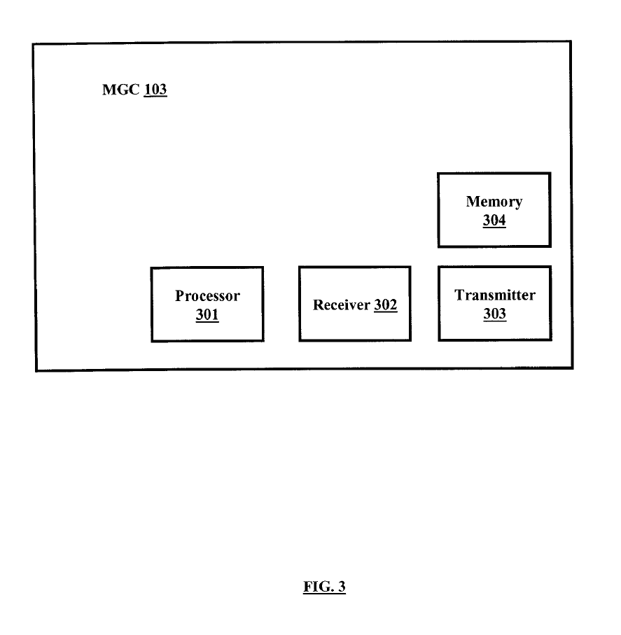

FIG. 3 is a block diagram of a Media Gateway Controller (MGC). A user 101 in an IN may communicate information to the network. The network initiates a recording session with the user 101, receives the information, records and stores the information. If the message is to be delivered to a destination user, then the network sends the message to the destination user. Before communicating the information, the user 101 initiates a communication link with the network. The user 101 may initiate the communication link by sending a request to the MGC 103. The MGC 103 receives the request through a receiver 302. On receiving the request from the user 101 and on determining that information has to be recorded from the user 101, the MGC 103 triggers the SCP 104. On being triggered, the SCP 104 instructs the MS 102, using the MGC 103, to establish a communication link with the user 101. When information has to be recorded from the user 101, the SCP 104 sends a prompt announcement to the MS 102 and instructs the MS 102 that information has to be recorded from the user 101. If an announcement has to be made to the user 101 before recording the information, then the SCP 104 also sends an announcement ID indicating the announcement to be played to user 101 before recording the information. After the announcement is played to the user 101, the user 101 can communicate the information to the MS 102 and the MS 102 records the received information. The message also includes recorded information ID and the control capabilities that can be used by the MS 102 to control the information recording session with the user. The SCP 104 then sends the message to the MS 102 through the MGC 103.

On receiving the message, the MGC 103 maps the message to a control information message that can be interpreted by the MS 102. For example, the MGC 103 may map the message to a SIP INFO message using Media Server Markup Language (MSML) format. The MGC 103 also maps the prompt announcement ID to the corresponding URL of the prompt announcement and the recorded information ID to the URL of the storage location of the recorded announcement. For example, if the prompt announcement ID indicates that the prompt announcement to be played to the user 101 is “Enter the message” and the prompt announcement is located at “location1” in the MS 102 and the name of the prompt announcement file is “ANN1.wav” then the URL of the prompt announcement may be “file:/location1/ANN1.wav”. If the recorded information ID indicates that the recorded information is to be stored in location “location2” under the name Rec1 then the URL of the storage location may be “file:/location2/Rec1.wav”. A processor 301 controls the functioning of the MGC 103. All the actions performed by the MGC 103 are coordinated by the processor 301. The processor 301 maps the message and the announcement ID received from the SCP 104 to the URL of the announcement. The URL of a corresponding announcement ID may be stored in a memory 304. The processor 301 also maps the recorded information ID to the URL of the location in the MS 102 where the recorded information is to be stored. The URL of the recorded information ID may also be stored in the memory 304. The processor 301 maps the URL of the announcement, URL of the storage location and the control capabilities to a message and then sends the message to the MS 102 using a transmitter 303.

On receiving the message from the MGC 103, the MS 102 determines that information has to be recorded from the user 101. The MS 102 locates the prompt announcement using the URL of the prompt announcement and plays the prompt announcement to the user 101. After the prompt announcement is played to the user 101, the user 101 may start communicating information to the MS 102. When the user 101 communicates the information to the MS 102, the MS 102 controls the recording session with the help of the control capabilities received from the SCP 104. The MS 102 takes the necessary steps in order to see to it that the recording session utilizes the control capabilities. After the user 101 completes communicating the information to the MS 102, the MS 102 stores the recorded information in the location indicated by the URL of the storage location.

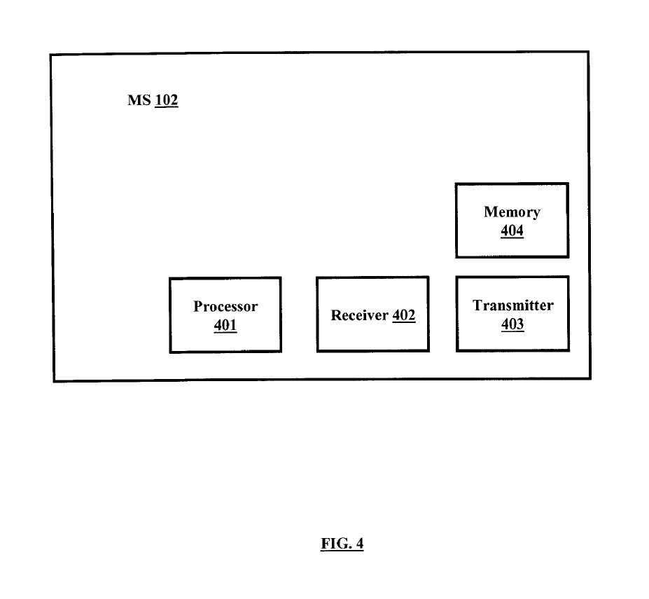

FIG. 4 is a block diagram of a Media Server (MS). A user 101 in an IN may communicate information to the network. The network initiates a recording session with the user 101, receives the information, records and stores the information. If the message is to be delivered to a destination user, then the network sends the message to the destination user. Before communicating the information, the user 101 initiates a communication link with the network. The user 101 may initiate the communication link by sending a request to the MGC 103. On receiving the request from the user 101 and on determining that information has to be recorded from the user 101, the MGC 103 triggers the SCP 104. On being triggered, the SCP 104 instructs the MS 102, using the MGC 103, to establish a communication link with the user 101. The MS 102 receives messages through a receiver 402. When information has to be recorded from the user 101, the SCP 104 sends a prompt announcement to the MS 102 and instructs the MS 102 that information has to be recorded from the user 101. If an announcement has to be made to the user 101 before recording the information, then the SCP 104 also sends an announcement ID indicating the announcement to be played to user 101 before recording the information. After the announcement is played to the user 101, the user 101 can communicate the information to the MS 102 and the MS 102 records the received information. The message also includes recorded information ID and the control capabilities that can be used by the MS 102 to control the information recording session with the user. The SCP 104 then sends the message to the MS 102 through the MGC 103.

On receiving the message, the MGC 103 maps the message to a control information message that can be interpreted by the MS 102. The MGC 103 also maps the prompt announcement ID to the corresponding URL of the prompt announcement and the recorded information ID to the URL of the storage location of the recorded announcement. The MGC 103 sends the URL of the prompt announcement, URL of the storage location and the control capabilities to the MS 102.

On receiving the message from the MGC 103, the MS 102 determines that information has to be recorded from the user 101. The MS 102 receives the message from the MGC 103 through the receiver 402. The MS 102 locates the prompt announcement using the URL of the prompt announcement and plays the prompt announcement to the user 101. The prompt announcement may be stored in the memory 404. A processor 401 controls the functioning of the MS 102. All the actions performed by the MS 102 are coordinated by the processor 401. The processor 401 locates the prompt announcement using the URL of the prompt announcement. The processor 401 plays the prompt announcement to the user 101 using a transmitter. The processor 401 may also convey the control options to the user 101 before recording the information communicated by the user 101. After the prompt announcement is played to the user 101, the user 101 may start communicating information to the MS 102. The MS 102 receives information from the user 101 through the receiver 402. When the user 101 communicates the information to the MS 102, the MS 102 controls the recording session with the help of the control capabilities received from the SCP 104. The MS 102 takes the necessary steps in order to see to it that the recording session utilizes the control capabilities. After the user 101 completes communicating the information to the MS 102, the MS 102 stores the recorded information in the memory 404. The recorded information would be stored in the memory 404 location indicated by the URL of the memory location. For example, the recorded information may be stored at location “location2” under the name Rec1.

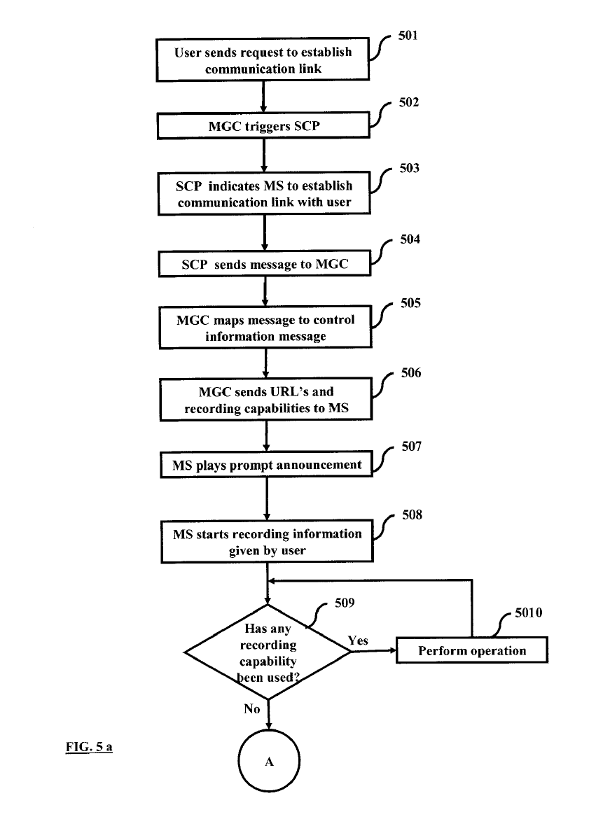

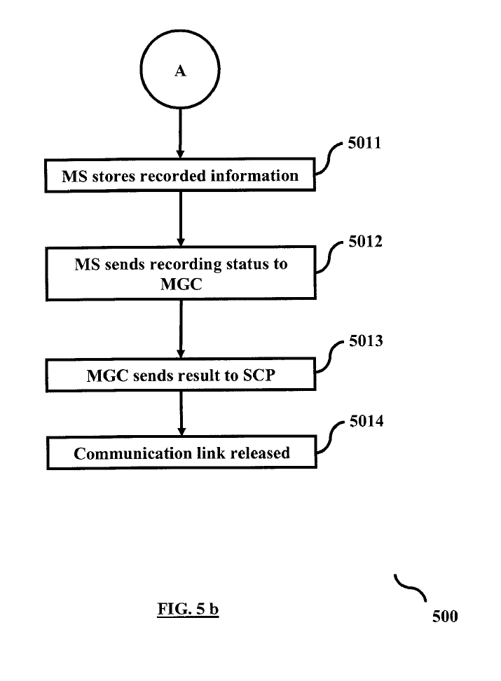

FIGS. 5a and 5b are flowcharts depicting a method for enabling control capabilities for information recording sessions. A user 101 in an IN may communicate information to the network. The network initiates a recording session with the user 101, receives the information, records and stores the information. Before communicating the information, the user 101 initiates (501) a communication link with the network. The user 101 may initiate the communication link by sending a request to the MGC 103. On receiving the request from the user 101 and on determining that information has to be recorded from the user 101, the MGC 103 triggers (502) the SCP 104. On being triggered, the SCP 104 instructs (503) the MS 102, using the MGC 103, to establish a communication link with the user 101. When information has to be recorded from the user 101, the SCP 104 sends a prompt announcement to the MS 102 and instructs the MS 102 that information has to be recorded from the user 101. If an announcement has to be made to the user 101 before recording the information, then the SCP 104 also sends an announcement ID indicating the announcement to be played to user 101 before recording the information. After the announcement is played to the user 101, the user 101 can communicate the information to the MS 102 and the MS 102 records the received information. The message also includes recorded information ID and the control capabilities that can be used by the MS 102 to control the information recording session with the user. The SCP 104 then sends (504) the message to the MS 102 through the MGC 103.

On receiving the message, the MGC 103 maps (505) the message to a control information message that can be interpreted by the MS 102. The MGC 103 also maps the prompt announcement ID to the corresponding URL of the prompt announcement and the recorded information ID to the URL of the storage location of the recorded announcement. The MGC 103 sends (506) the URL of the prompt announcement, URL of the storage location and the control capabilities to the MS 102.

On receiving the message from the MGC 103, the MS 102 determines that information has to be recorded from the user 101. The MS 102 locates the prompt announcement using the URL of the prompt announcement and plays (507) the prompt announcement to the user 101. After the prompt announcement is played to the user 101, the user 101 may start communicating information to the MS 102 and the MS 102 would record (508) the received information. When the user 101 communicates the information to the MS 102, the MS 102 controls the recording session with the help of the control capabilities received from the SCP 104. The MS 102 takes the necessary steps in order to see to it that the recording session utilizes the control capabilities. If any control capability is to be used (509) during the recording session, then the MS 102 performs (5010) the necessary actions to use the control capability and control the recording session. After the user 101 completes communicating the information to the MS 102, the MS 102 stores (5011) the recorded information. The recorded information would be stored in the memory location indicated by the URL of the memory location. After the recording session is complete, the MS 102 sends (5012) the status of the recording session to the MGC 103. For example, if the session is complete, then the MS 102 may send the status of the session as “Complete”, to the MGC 103. The MGC 103 sends (5013) the status of the session, to the SCP 104. Once the recording session is complete, the communication link with the user 101 may be released (5014). The various actions in method 500 may be performed in the order presented, in a different order or simultaneously. Further, in some embodiments, some actions listed in FIG. 5 may be omitted.

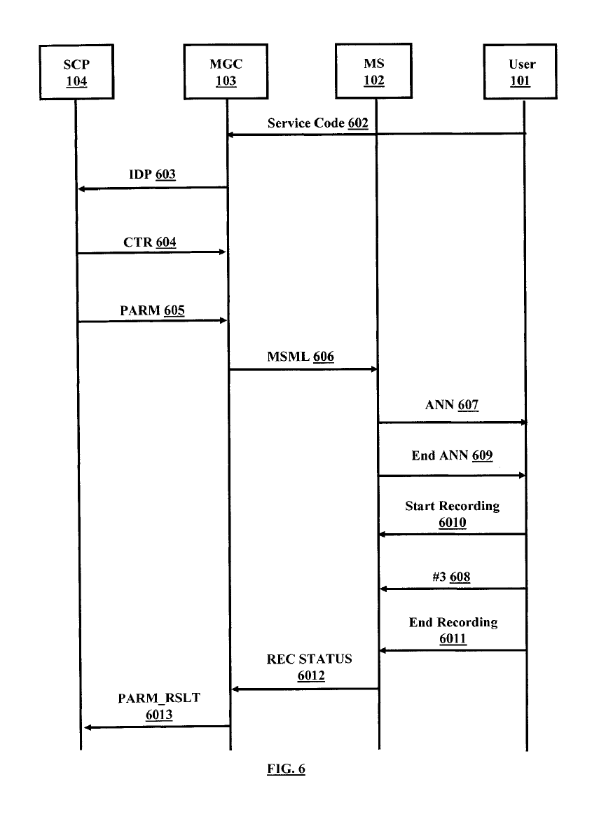

FIG. 6 illustrates a flow diagram for an example illustrating use of a control capability during an information recording session. A user 101 in an IN may communicate information to the network. The network initiates a recording session with the user 101, receives the information, records and stores the information. Before communicating the information, the user 101 initiates a communication link with the network. The user 101 may initiate the communication link by sending a request to the MGC 103. If the user 101 wants to avail of any specific service offered by the network, then the user 101 also sends the Service code 602 of the service along with the request. On receiving the request from the user 101, and on determining that information may be transferred between the user 101 and the network, the MGC 103 triggers the SCP 104. The MGC 103 may trigger the SCP 104 by sending an Initial Detection Point (IDP) 603 to the SCP 104. On being triggered, the SCP 104 instructs the MS 102, using the MGC 103, to start a communication session with the user 101. The SCP 104 sends a message to the MS 102, through the MGC 103, to instruct the MS 102. The SCP 104 may send a Connect to Resource (CTR) 604 message to the MGC 103 and the MGC 103 may send an invitation message to the MS 102. The MS 102 then establishes a communication session with the user 101.

From the request message and the service code number entered by the user 101, the SCP 104 determines that information would have to be received and recorded from the user 101. The SCP 104 sends a PARM 605 to the MGC 103 in order to play a prompt announcement to the user 101 and receive information from the user 101. The SCP 104 sends an announcement ID, recorded information ID and the control capabilities in the PARM 605. On receiving the prompt announcement ID from the SCP 104, the MGC 103 maps the prompt announcement ID to the corresponding URL of the announcement and the recorded information ID to the URL of the storage location of the recorded announcement and sends the URL's to the MS 102. The MGC 103 may send the URL's as a SIP info message in MSML 606 format. The MGC 103 also informs the MS 102 that information may have to be received from the user 101. The MGC 103 also maps the control capabilities received from the SCP 104 and sends the control capabilities to the MS 102 in the MSML 606 message. On receiving the message from the MGC 103, the MS 102 locates the announcement using the URL of the announcement and plays the announcement to the user 101. The announcement may be played as an ANN 607 message and the announcement may be played to the user 101 through a Real-time Transport Protocol (RTP) connection between the user 101 and the MS 102. The completion of the prompt announcement is indicated as End ANN 609. After the announcement is complete, the user 101 can start communicating information to the MS 102. When the user 101 is communicating the information, the MS 102 can Start Recording 6010 the information. While the MS 102 records the information, if the user 101 wishes to pause the recording session, then the user 101 can exercise the control capability for pausing the recording session. The user 101 may enter “#3” 608 on a communication terminal to pause the recording session. When the MS 102 receives the command to pause the recording session, the MS 102 stops recording information from the user 101 for a pre-determined duration of time. Once the pre-determined duration of time elapses, the MS 102 resumes the recording session. The MS 102 may also resume the recording session, if the user 101 exercises the control option “Resumedigit” in order to resume the recording session. When the user 101 completes communicating the information, the MS 102 stops the recording process, indicated as End Recording 6011. After the MS 102 has completed replaying the information, the MS 102 sends the status of the recording session to the MGC 103. The MS 102 may send the status of the recording as a REC STATUS 6012 message. The MGC 103 then sends the status of the PARM session to the SCP 104. The MGC 103 may send the status as a PARM_RSLT 6013.

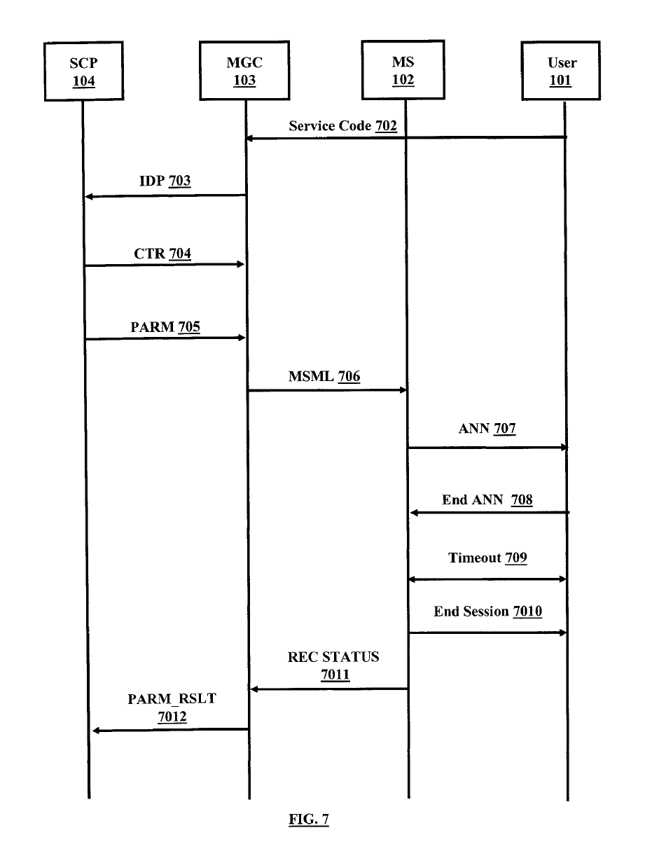

FIG. 7 illustrates a flow diagram for an example illustrating use of a control capability during an information recording session. A user 101 in an IN may communicate information to the network. The network initiates a recording session with the user 101, receives the information, records and stores the information. Before communicating the information, the user 101 initiates a communication link with the network. The user 101 may initiate the communication link by sending a request to the MGC 103. If the user 101 wants to avail of any specific service offered by the network, then the user 101 also sends the Service code 702 of the service along with the request. On receiving the request from the user 101, and on determining that information may be transferred between the user 101 and the network, the MGC 103 triggers the SCP 104. The MGC 103 may trigger the SCP 104 by sending an IDP 703 to the SCP 104. On being triggered, the SCP 104 instructs the MS 102, using the MGC 103, to start a communication session with the user 101. The SCP 104 sends a message to the MS 102, through the MGC 103, to instruct the MS 102. The SCP 104 may send a CTR 704 message to the MGC 103 and the MGC 103 may send an invitation message to the MS 102. The MS 102 then establishes a communication session with the user 101.

From the request message and the service code number entered by the user 101, the SCP 104 determines that information would have to be received and recorded from the user 101. The SCP 104 sends a PARM 705 to the MGC 103 in order to play a prompt announcement to the user 101 and receive information from the user 101. The SCP 104 sends an announcement ID, recorded information ID and the control capabilities in the PARM 705. On receiving the prompt announcement ID from the SCP 104, the MGC 103 maps the prompt announcement ID to the corresponding URL of the announcement and the recorded information ID to the URL of the storage location of the recorded announcement and sends the URL's to the MS 102. The MGC 103 may send the URL's as a SIP info message in MSML 706 format. The MGC 103 also informs the MS 102 that information may have to be received from the user 101. The MGC 103 also maps the control capabilities received from the SCP 104 and sends the control capabilities to the MS 102 in the MSML 706 message. On receiving the message from the MGC 103, the MS 102 locates the announcement using the URL of the announcement and plays the announcement to the user 101. The announcement may be played as an ANN 707 message and the announcement may be played to the user 101 through an RTP connection between the user 101 and the MS 102. After the prompt announcement is completely played to the user 101, indicated as End ANN 708, the user 101 may start communicating information to the MS 102 and the MS 102 can record the received information. When the user 101 communicates the information to the MS 102, the MS 102 controls the recording session with the help of the control capabilities received from the SCP 104. There is a pre-determined time period within which the user 101 has to start communicating the information to the MS 102. The pre-determined time period is indicated as Timeout 709. If the user 101 does not start communicating the information before the expiry of the Timeout 709 period, then the MS 102 may end the current information recording session. The MS 102 ends the current session as indicated as End Session 7010. After the MS 102 has completed replaying the information, the MS 102 sends the status of the recording session to the MGC 103. The MS 102 may send the status of the recording as a REC STATUS 7011 message. The MGC 103 then sends the status of the PARM session to the SCP 104. The MGC 103 may send the status as a PARM_RSLT 7012.

The embodiments disclosed herein can be implemented through at least one software program running on at least one hardware device and performing network management functions to control the network elements. The network elements shown in FIG. 1, FIG. 2, FIG. 3 and FIG. 4 include blocks which can be at least one of a hardware device, or a combination of hardware device and software module.

The embodiment disclosed herein specifies system and method for enabling control capabilities for information recording sessions with a user in an IN. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL), any other coding language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A method for enabling control capabilities for information recording session with a user in an Intelligent Network, said network comprising a Media Gateway Controller (103), a Service Control Point (104) and a Media Server (102), said method comprising steps of:
said Service Control Point (104) sending said control capabilities to said Media Gateway Controller (103);
said Media Gateway Controller (103) mapping said control capabilities to a control information message;
said Media Gateway Controller (103) sending said control information message to said Media Server (102); and
said Media Server (102) controlling said information recording session based on said control capabilities present in said control information message.

2. The method, as claimed in claim 1, wherein said Service Control Point (104) sends said control capabilities to said Media Gateway Controller (103) in a Prompt and Receive Message (PARM).

3. The method, as claimed in claim 1, wherein said Media Gateway Controller (103) maps said control capabilities to a Session Initiation Protocol (SIP) INFO message using Media Server Markup Language (MSML) format.

4. The method, as claimed in claim 1, wherein said control capabilities comprises at least one of:
time period within which said information recording session should start;
allowed time period of silence in said information recording session;
voice activity detection to start said information recording session;
voice activity detection to end said information recording session;
playing a beep sound during said information recording session;
appending recorded information to a recording location;
pause said recording session; and
resume said information recording session.

5. The method, as claimed in claim 1, said network uses at least one of:
Intelligent Network Application Part (INAP); and
Customized Applications for Mobile Network Enhanced Logic (CAMEL).

6. A Service Control Point (104) for enabling control capabilities for information recording session with a user in an Intelligent Network, said network further comprising a Media Gateway Controller (103) and a Media Server (102), said Service Control Point (104) having at least one means adapted for:
sending said control capabilities to said Media Gateway Controller (103) to enable said Media Server (102) to control said information recording session.

7. The Service Control Point (104), as claimed in claim 6, wherein said Service Control Point (104) is adapted to send said control capabilities to said Media Gateway Controller (103) in a Prompt and Receive Message (PARM).

8. A Media Gateway Controller (103) for enabling control capabilities for information recording session with a user in an Intelligent Network, said network further comprising a Service Control Point (104) and a Media Server (102), said Media Gateway Controller (103) having at least one means adapted for:
receiving said control capabilities from a Service Control Point (104);
mapping said control capabilities to a control information message; and
sending said control information message to said Media Server (102).

9. The Media Gateway Controller (103), as claimed in claim 8, wherein said Media Gateway Controller (103) is adapted to map said control capabilities to a Session Initiation Protocol (SIP) INFO message using Media Server Markup Language (MSML) format.

10. A Media Server (102) for enabling control capabilities for information recording session with a user in an Intelligent Network, said network further comprising a Service Control Point (104) and a Media Gateway Controller (103), said Media Server (102) having at least one means adapted for:
receiving said control capabilities from said Media Gateway Controller (103) in a control information message; and
controlling said information recording session based on said control capabilities present in said control information message.

11. The Media Server (102), as claimed in claim 10, wherein said Media Server (102) is adapted to receive said control information message in a Session Initiation Protocol (SIP) INFO message using Media Server Markup Language (MSML) format.

12. The Media Server (102), as claimed in claim 10, wherein said network uses at least one of:
Intelligent Network Application Part (INAP); and Customized Applications for Mobile Network Enhanced Logic (CAMEL).

13. A system for enabling control capabilities for information recording session with a user in an Intelligent Network, said network further comprising a Media Gateway Controller (103), a Service Control Point (104) and a Media Server (102), said system comprising of:
said Service Control Point (104) sending said control capabilities to said Media Gateway Controller (103);
said Media Gateway Controller (103) mapping said control capabilities to a control information message;
said Media Gateway Controller (103) sending said control information message to said Media Server (102);
said Media Server (102) controlling of said information recording session based on said control capabilities.

14. The system, as claimed in claim 13, wherein said Service Control Point (104) is adapted to send said control capabilities to said Media Gateway Controller (103) in a Prompt and Receive Message (PARM).

15. The system, as claimed in claim 13, wherein said Media Gateway Controller (103) is adapted to map said control capabilities to a Session Initiation Protocol (SIP) INFO message using Media Server Markup Language (MSML) format.
